(19) United States
(12) Patent Application Publication
(10) Pub. No.: US 2013/0159339 A1
(43) Pub. Date: Jun. 20, 2013

(54) Data Container Access in a Database System

(71) Applicants: Dirk Thomsen, Heidelberg (DE); Axel Schroeder, Walldorf (DE); Ivan Schreter, Malsch (DE)

(72) Inventors: Dirk Thomsen, Heidelberg (DE); Axel Schroeder, Walldorf (DE); Ivan Schreter, Malsch (DE)

(73) Assignee: SAP AG

(21) Appl. No.: 13/329,552

(22) Filed: Dec. 19, 2011

(51) Int. Cl. G06F 17/30

(52) U.S. Cl. 707/769; 707/E17.014

(57) ABSTRACT

A database system receives a request to access one of a plurality of data containers. Such request includes a file identification (ID) corresponding to the requested data container. Using this file ID, metadata associated with the requested data container is accessed. The metadata is stored in a page of page chain and such metadata identifies a location of the requested data container (so that it can be accessed). Thereafter, the metadata is used to enable access to the requested data container. The file ID in the request can encapsulate a page number and at least one index. This page number identifies a page in the page chain storing the metadata and the index identifies a location within the identified page where the metadata can be found. Related apparatus, systems, techniques and articles are also described.

### TECHNICAL FIELD

The subject matter described herein relates to techniques for accessing data containers within a database system using a lookup directory.

### BACKGROUND

Accessing data containers within a database system typically requires accessing metadata that identifies the location of the data container. This metadata can sometimes be stored in a hierarchy of pages having a root directory page stored on a master node of the hierarchy. When a request is first received to access a particular data container, metadata is first read from the root directory stored on the a master node. The root directory, in turn, identifies a particular child node storing the metadata. A tree traversal operation is then initiated which requires traversal of at least two nodes in order to access the metadata associated with the data container. This metadata is then used to identify and access the location of the requested data container.

One type of hierarchy of pages is a B*-tree structure. With a B*-tree structure keys (e.g., container IDS) are stored in internal nodes and leaf nodes store the records corresponding to such keys (and in some cases the keys are also stored on leaf nodes). The tree propagates when a node gets full—which results in keys being shared by a neighboring node. When both nodes are full, the two nodes are split into three nodes. With large-scale database systems storing metadata in such a fashion, the number of nodes within the page hierarchy can become voluminous very quickly. As a result, access of a certain node can be delayed due to the traversal of numerous nodes.

### SUMMARY

In one aspect, a database system receives a request to access one of a plurality of data containers. Such request includes a file identification (ID) corresponding to the requested data container. Using this file ID, metadata associated with the requested data container is accessed. The metadata is stored in a page of page chain and such metadata identifies a location of the requested data container (so that it can be accessed). Thereafter, the metadata is used to enable access to the requested data container. The file ID in the request can encapsulate a page number and at least one index. This page number identifies a page in the page chain storing the metadata and the index identifies a location within the identified page where the metadata can be found.

The pages in the page chain can have fixed or varying sizes. Metadata for particular data containers stored on the pages can have varying sizes. Each page in the page chain can include a logical page number. The database system can be and/or include an in-memory database.

Articles of manufacture are also described that comprise computer executable instructions permanently stored on non-transitory computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. In addition, operations specified by methods can be implemented by one or more data processors either within a single computing system or distributed among two or more computing systems.

The subject matter described herein provides many advantages. For example, the current subject matter enables faster metadata lookup as compared to conventional arrangements such as B*-tree structures. In addition, the current subject matter is advantageous in that it consumes fewer processing resources as compared to traversing trees.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a system including a data storage application;

FIG. 2 is a process flow diagram illustrating a technique for accessing data containers using metadata;

FIG. 3 is a diagram illustrating details of the system of FIG. 1; and

FIG. 4 is a diagram illustrating a plurality of pages encapsulating metadata which in the aggregate form a page chain.

Like reference symbols in the various drawings indicate like elements.

### DETAILED DESCRIPTION

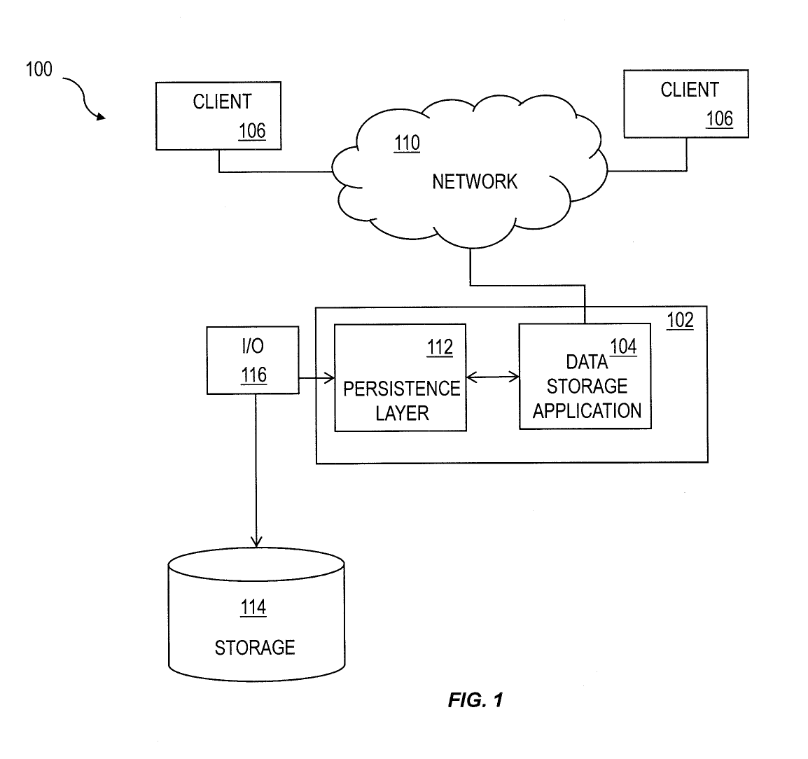

FIG. 1 shows an example of a system 100 in which a computing system 102, which can include one or more programmable processors that can be collocated, linked over one or more networks, etc., executes one or more modules, software components, or the like of a data storage application 104. The data storage application 104 can include one or more of a database, an enterprise resource program, a distributed storage system (e.g. NetApp Filer available from NetApp of Sunnyvale, CA), or the like.

The one or more modules, software components, or the like can be accessible to local users of the computing system 102 as well as to remote users accessing the computing system 102 from one or more client machines 106 over a network connection 110. One or more user interface screens produced by the one or more first modules can be displayed to a user, either via a local display or via a display associated with one of the client machines 106. Data units of the data storage application 104 can be transiently stored in a persistence layer 112 (e.g. a page buffer or other type of temporary persistency layer), which can write the data, in the form of storage pages, to one or more storages 114, for example via an input/output component 116. The one or more storages 114 can include one or more physical storage media or devices (e.g. hard disk drives, persistent flash memory, random access memory, optical media, magnetic media, and the like) configured for writing data for longer term storage. It should be noted that the storage 114 and the input/output component 116 can be included in the computing system 102 despite their being shown as external to the computing system 102 in FIG. 1.

Data retained at the longer term storage 114 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

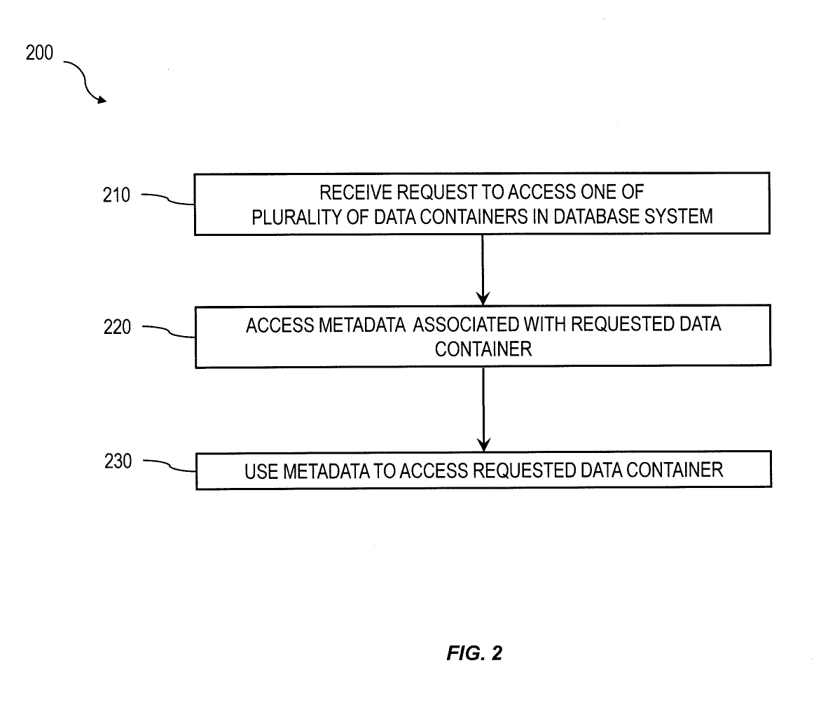

FIG. 2 is a process flow diagram 200 in which, at 210, a database system (such as the database system 100 of FIG. 1) receives a request to access one of a plurality of data containers. Such request includes a file identification (ID) corresponding to the requested data container. Using this file ID, at 220, metadata associated with the requested data container is accessed. The metadata is stored in a page of page chain and such metadata identifies a location of the requested data container (so that it can be accessed). Thereafter, at 230, the metadata is used to enable access to the requested data container. The file ID in the request can encapsulate a page number and at least one index. This page number identifies a page in the page chain storing the metadata and the index identifies a location within the identified page where the metadata can be found.

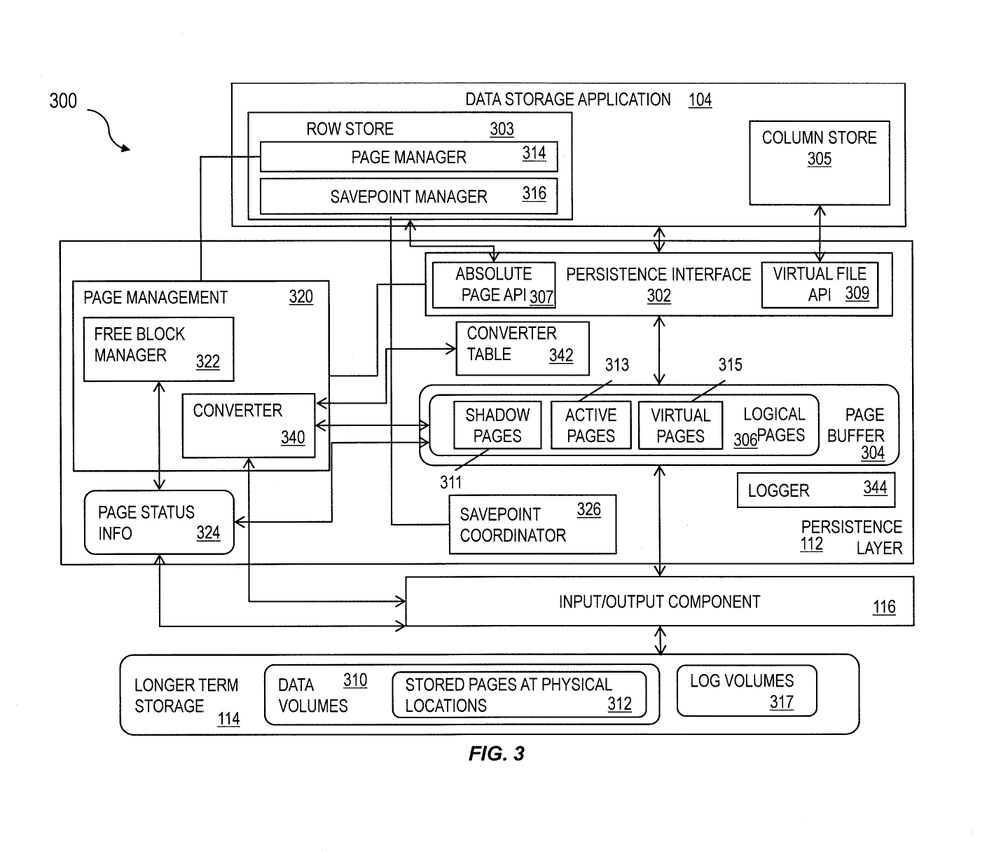

FIG. 3 shows a software architecture 300 consistent with one or more features of the current subject matter. A data storage application 104, which can be implemented in one or more of hardware and software, can include one or more of a database application, a network-attached storage system, or the like. According to at least some implementations of the current subject matter, such a data storage application 104 can include or otherwise interface with a persistence layer 112 or other type of memory buffer, for example via a persistence interface 302. A page buffer 304 within the persistence layer 112 can store one or more logical pages 306, and optionally can include shadow pages, active pages, and the like. The logical pages 306 retained in the persistence layer 112 can be written to a storage (e.g. a longer term storage, etc.) 114 via an input/output component 116, which can be a software module, a sub-system implemented in one or more of software and hardware, or the like. The storage 114 can include one or more data volumes 310 where stored pages 312 are allocated at physical memory blocks.

In some implementations, the data storage application 104 can include or be otherwise in communication with a page manager 314 and/or a savepoint manager 316. The page manager 314 can communicate with a page management module 320 at the persistence layer 112 that can include a free block manager 322 that monitors page status information 324, for example the status of physical pages within the storage 114 and logical pages in the persistence layer 112 (and optionally in the page buffer 304). The savepoint manager 316 can communicate with a savepoint coordinator 326 at the persistence layer 204 to handle savepoints, which are used to create a consistent persistent state of the database for restart after a possible crash.

In some implementations of a data storage application 104, the page management module of the persistence layer 112 can implement a shadow paging. The free block manager 322 within the page management module 320 can maintain the status of physical pages. The page buffer 304 can included a fixed page status buffer that operates as discussed herein. A converter component 340, which can be part of or in communication with the page management module 320, can be responsible for mapping between logical and physical pages written to the storage 114. The converter 340 can maintain the current mapping of logical pages to the corresponding physical pages in a converter table 342. The converter 340 can maintain a current mapping of logical pages 306 to the corresponding physical pages in one or more converter tables 342. When a logical page 306 is read from storage 114, the storage page to be loaded can be looked up from the one or more converter tables 342 using the converter 340. When a logical page is written to storage 114 the first time after a savepoint, a new free physical page is assigned to the logical page. The free block manager 322 marks the new physical page as “used” and the new mapping is stored in the one or more converter tables 342.

The persistence layer 112 can ensure that changes made in the data storage application 104 are durable and that the data storage application 104 can be restored to a most recent committed state after a restart. Writing data to the storage 114 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 344 can also be included to store the changes made to the data of the data storage application in a linear log. The logger component 344 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 344 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 112 can use a combination of undo log entries (from one or more logs) and shadow paging.

The persistence interface 302 can handle read and write requests of stores (e.g., in-memory stores, etc.). The persistence interface 302 can also provide write methods for writing data both with logging and without logging. If the logged write operations are used, the persistence interface 302 invokes the logger 344. In addition, the logger 344 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 344. For an entry of type “update”, for example, this would be the identification of the affected record and the after image of the modified data.

When the data application 104 is restarted, the log entries need to be processed. To speed up this process the redo log is not always processed from the beginning. Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 344 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 344 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 344 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

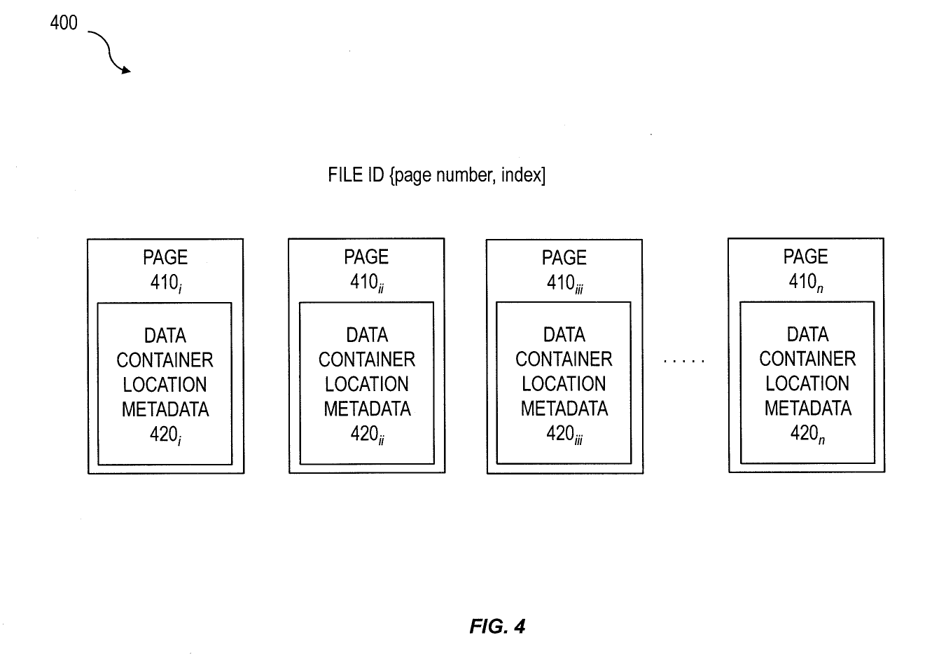

FIG. 4 is a diagram 400 illustrating a plurality of pages 410_{i . . . n} which are linked to form a page chain. Each page 410_{i . . . n} stores metadata 420_{i . . . n} that corresponds to one or more data containers (i.e., pages, data objects, etc.) within the database system 100. This metadata 420_{i . . . n} identifies a location of an actual table/columnar data corresponding to a requested data container (e.g., first page in case of a page chain or a root page in case of a B* tree). A request to access the data container can include a file identification (ID) (normally an 8 or 16 byte value, e.g. 0x672341234). In this case, the file ID encapsulates both an identification of a page 410_{i . . . n} in the page chain as well as an index/offset that indicates where on the page 410_{i . . . n} the metadata associated with the file ID resides. When a request is received to access a data container, the page number from the file ID is used to directly access the corresponding page 410_{i . . . n} and the index is used to specify where on that page 410_{i . . . n} the particular metadata 420_{i . . . n} relating to the requested data container resided. Such an arrangement obviates the need for B* tree traversal thereby allowing access of metadata with 0(1) effort.

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A method comprising:
receiving, in a database system, a request to access one of a plurality of data containers, the request comprising a file identification (ID) corresponding to the requested data container;
accessing metadata associated with the requested data container based on the file ID, the metadata being stored in a page of a page chain and identifying a location of the requested data container; and
using the metadata to enable access to the requested data container.

2. A method as in claim 1, wherein the file ID encapsulates a page number and at least one index, the page number identifying a page in the page chain storing the metadata and the index identifying a location within the identified page where the metadata can be found.

3. A method as in claim 1, wherein the pages in the page chain have fixed sizes.

4. A method as in claim 1, wherein the pages in the page chain have varying sizes.

5. A method as in claim 1, wherein metadata for particular data containers stored on the pages have varying sizes.

6. A method as in claim 1, wherein each page in the page chain comprises a logical page number.

7. A method as in claim 1, wherein the database system comprises an in-memory database.

8. A computer program product comprising a non-transitory machine-readable medium storing instructions that, when executed by at least one programmable processor, cause the at least one programmable processor to perform operations comprising:
receiving, in a database system, a request to access one of a plurality of data containers, the request comprising a file identification (ID) corresponding to the requested data container;
accessing metadata associated with the requested data container based on the file ID, the metadata being stored in a page of a page chain and identifying a location of the requested data container; and
using the metadata to enable access to the requested data container.

9. A computer program product as in claim 8, wherein the file ID encapsulates a page number and at least one index, the page number identifying a page in the page chain storing the metadata and the index identifying a location within the identified page where the metadata can be found.

10. A computer program product as in claim 8, wherein the pages in the page chain have fixed sizes.

11. A computer program product as in claim 8, wherein the pages in the page chain have varying sizes.

12. A computer program product as in claim 8, wherein metadata for particular data containers stored on the pages have varying sizes.

13. A computer program product as in claim 8, wherein each page in the page chain comprises a logical page number.

14. A computer program product as in claim 8, wherein the database system comprises an in-memory database.

15. A system comprising:
at least one data processor;
memory coupled to the at least one data processor, the memory storing instructions, which when executed, cause the at least one data processor to perform operations comprising
receiving, in a database system, a request to access one of a plurality of data containers, the request comprising a file identification (ID) corresponding to the requested data container;
accessing metadata associated with the requested data container based on the file ID, the metadata being stored in a page of a page chain and identifying a location of the requested data container, wherein the file ID encapsulates a page number and at least one index, the page number identifying a page in the page chain storing the metadata and the index identifying a location within the identified page where the metadata can be found; and
using the metadata to enable access to the requested data container.

16. A system as in claim 15, wherein the pages in the page chain have fixed sizes.

17. A system as in claim 15, wherein the pages in the page chain have varying sizes.

18. A system as in claim 15, wherein metadata for particular data containers stored on the pages have varying sizes.

19. A system as in claim 15, wherein each page in the page chain comprises a logical page number.

20. A system as in claim 15, wherein the database system comprises an in-memory database.
